(19) United States
(12) Patent Application Publication
(10) Pub. No.: US 2006/0230419 A1
(43) Pub. Date: Oct. 12, 2006

(54) Image forming and reproducing apparatus with mode controllable communication interface

(76) Inventor: Fumiyuki Yoshida, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/395,187

(22) Filed: Apr. 3, 2006

(30) Foreign Application Priority Data
Apr. 8, 2005 (JP) 2005-112435

(51) Int. Cl. H04N 7/16; H04N 7/173; H04N 7/18

(52) U.S. Cl. 725/80; 725/117; 725/147

(57) ABSTRACT

An image forming and reproducing apparatus furnished with one or more communication interfaces connectable to external devices so as to transmit and receive image data items to and from the external devices is provided. The image forming and reproducing apparatus comprises a communication interface mode setting unit configured to allow a user to set each of the communication interfaces in a usable mode or a unusable mode; and a controller configured to detect the current mode of each of the communication interfaces when the image forming and reproducing apparatus is powered on and to determine whether to initialize each of the communication interfaces based on the detected mode.

### BACKGROUND OF THE INVENTION

1. Field of the Invention

The present invention relates to an image forming and reproducing apparatus capable of controlling input and output of multiple types of image data through communication interfaces.

2. Description of Related Art

In recent years and continuing, so-called multi-function image reproducing apparatuses with multiple types of image reproducing functions, such as a copy function, a facsimile function, a scanner function, or a printer function, have been put into practical use. Some multi-function image reproducing apparatuses have a power-save mode to reduce power consumption. For example, it is proposed to regulate the power source supply to the internal circuits of the apparatus so as to reduce power consumption as much as possible in the standby state, or to activate only the minimum and necessary circuits when the apparatus recovers from the power-save mode. See Japanese Patent Application Laid-opened Publication No. JP 7-226815A and Japanese Patent No. 3500297.

Recent image reproducing apparatuses are furnished with standardized network functions. For example, because a universal serial bus (USB) interface is generally installed in a personal computer as one of the standard specifications, an image reproducing apparatus is also furnished with a standardized USB interface so as to be connected to the personal computer.

However, such a USB interface installed in the image reproducing apparatus is not always used. Some users may wish to use only the photocopy function without connecting the multi-function image reproducing apparatus with a personal computer. The conventional multi-function image reproducing apparatus is designed such that the USB interface function is always available even through the interface function is not actually used.

If all the functions, including the USB interface, of the image reproducing apparatus are maintained in the available or usable state, users can use the desired function any time whenever they wish. However, keeping the functions used not so often in the usable state leads to uneconomical power consumption. In addition, an initialization process is carried out by the universal operating system of the image reproducing apparatus upon power-on of the apparatus in order to make the installed functions available for the users even if some of the functions are not often used. The initialization process takes a long time until the image reproducing apparatus is brought into the operative state.

It is desired for the image reproducing apparatus to be able to flexibly control the not-so-often used functions, such as communication interfaces including USB interfaces, to be in the unusable state and to easily restore the functions from the unusable mode with a simple manipulation whenever users wish to use the suspended functions.

### SUMMARY OF THE INVENTION

The present invention was conceived in view of the above-described issues, and it is an object of the invention to provide an image forming and reproducing technique capable of reducing power consumption and startup time of the image forming and reproducing apparatus by selectively not starting communication interfaces not currently in use.

In one aspect of the invention, an image forming and reproducing apparatus furnished with one or more communication interfaces connectable to external devices so as to transmit and receive image data items to and from the external devices is provided. The image forming and reproducing apparatus comprises:

(a) a communication interface mode setting unit configured to allow a user to set each of the communication interfaces in a usable mode or an unusable mode; and

(b) a controller configured to detect the current mode of each of the communication interfaces when the image forming and reproducing apparatus is powered on and to determine whether to initialize each of the communication interfaces based on the detected mode.

In a preferred example, the image forming and reproducing apparatus may further have a storage unit to store the modes of the communication interfaces. In this case, the controller reads the modes of the communication interfaces from the storage unit to determine whether to initialize the communication interfaces when the image forming and reproducing apparatus is powered on.

In another example, the image forming and reproducing apparatus further has a bootstrap unit configured to start up the image forming and reproducing apparatus when the image forming and reproducing apparatus is powered on. In this case, the controller causes the bootstrap unit not to start up the communication interface set in the unusable mode.

In still another example, the image forming and reproducing apparatus further has one or more device drivers provided corresponding to the communication interfaces. In this case, if the communication interface is in the unusable mode, the controller does not activate the associated device driver when the image forming and reproducing apparatus is powered on.

### BRIEF DESCRIPTION OF THE DRAWINGS

Other objects, features, and advantages of the invention will become more apparent from the following detailed description when read in conjunction with the accompanying drawings, in which:

FIG. 1 is a functional block diagram of an image forming and reproducing apparatus according to an embodiment of the invention;

FIG. 2 is a functional block diagram of the universal operating system (OS) used in the image forming and reproducing apparatus shown in FIG. 1;

FIG. 3A is an example of a network interface use/nonuse switching screen displayed in the operations panel of the image forming and reproducing apparatus, FIG. 3B is an example of a message screen reporting setup of the network interface usable mode, and FIG. 3C is an example of a message screen reporting setup of the network interface unusable mode;

FIG. 4 is a flowchart showing the operations of a network interface use/nonuse setting process performed according to the instruction input instructed through the operations panel;

FIG. 5 is a flowchart showing the communication interface suspending operations in the bootstrap process; and

FIG. 6 is a flowchart of the device detection process of the device driver.

### DETAINED DESCRIPTION OF THE PREFERRED EMBODIMENTS

The preferred embodiment of the present invention is described below in conjunction with the attached drawings.

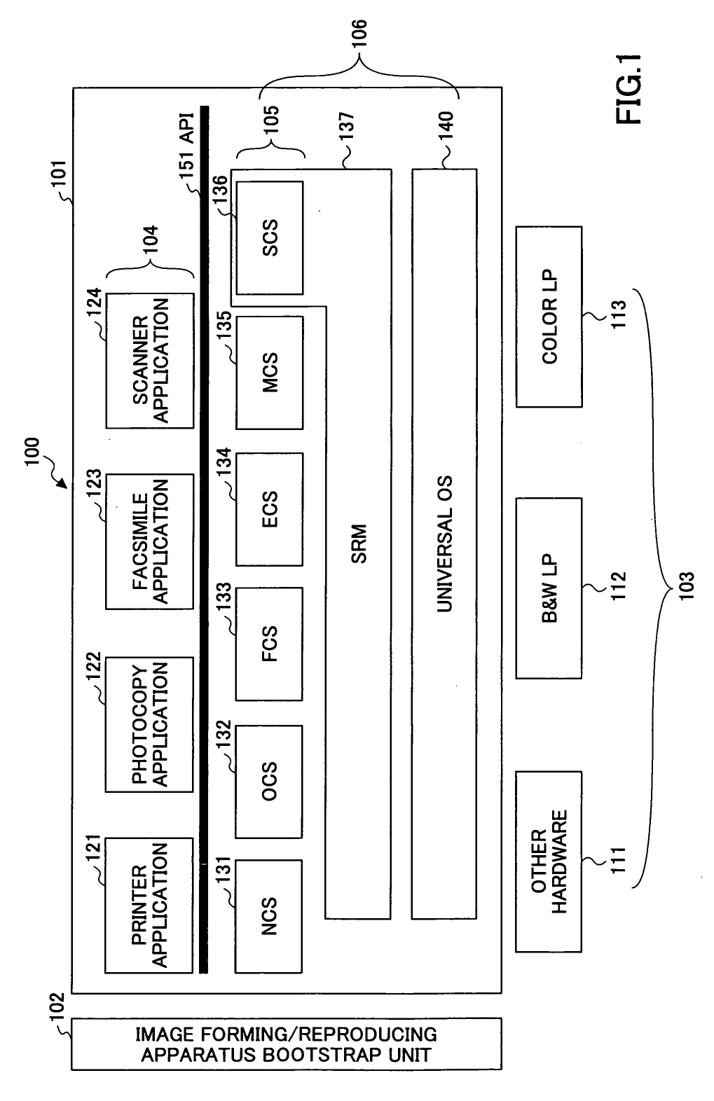

First, the structure and the functions of an image forming and reproducing apparatus (hereinafter, referred to as “image forming/reproducing apparatus”) is explained. FIG. 1 is a functional block diagram of the image forming/reproducing apparatus 100 according to an embodiment of the invention. The apparatus 100 has multiple types of image reproducing functions with corresponding applications installed therein so to as to be able to serve as a printer, a copying machine, a facsimile machine, or a scanner. The image forming/reproducing apparatus 100 includes a software block 101 serving as control means, an image forming/reproducing apparatus bootstrap unit 102, and hardware resources 103.

The image forming/reproducing apparatus bootstrap unit 102 is first activated to start the application layer 104 and the platform 106 when the image forming/reproducing apparatus 100 is powered on. The hardware resources 103 includes a black and white laser printer (B&W LP) 112, a color laser printer (Color LP) 113, and other hardware 111 (such as a scanner or a facsimile machine).

The software block 101 includes the application layer 104 implemented on the operating system, such as UNIX (registered trademark), and the platform 106. The application layer 104 comprises a program for executing a specific process for each of the multiple types of image forming/reproducing functions, and includes in this example a printer application 121, a photocopy application 122, a facsimile application 123, and a scanner application 124.

The platform 106 includes a control service layer 105 that interprets a job request from the application layer 104 and generates a request for acquiring a corresponding hardware resource from the hardware resources 103. In addition, the platform 106 includes a system resources manager (SRM) 137 for managing the hardware resources 103 to intervene between the hardware resource acquisition requests supplied from the control service layer 105 and the universal operation system 140 actually operating the hardware resources 103 according to the hardware resource acquisition request from the SRM 137.

The control service layer 105 includes one or more service modules, and in this example, a network control service (NCS) 131, an operations panel control service (OCS) 132, a facsimile control service (FCS) 133, an engine control service (ECS) 134, a memory control service (MCS) 135, and a system control service (SCS) 136 are provided.

The platform 106 is configured to deal with a job request supplied from the application layer 104 via an application program interface (API) 151 that makes the job request acceptable at the platform 106 according to the prescribed functions. The operating system, such as UNIX (registered trademark) executes multiple processes, that is, software items in the application layer 104 and the platform 106, in parallel.

The process of NCS 131 provides a service available among those applications that require network input/output (I/O) performance. This service distributes data items received from the network under several protocols to the corresponding applications, and mediates data items supplied from each application so as to be transmitted to the network. The NCS 131 controls data communications between the image forming/reproducing apparatus 100 and network equipment and devices connected via the network using, for example, hypertext transfer protocol daemon (httpd) of the hypertext transfer protocol (HTTP).

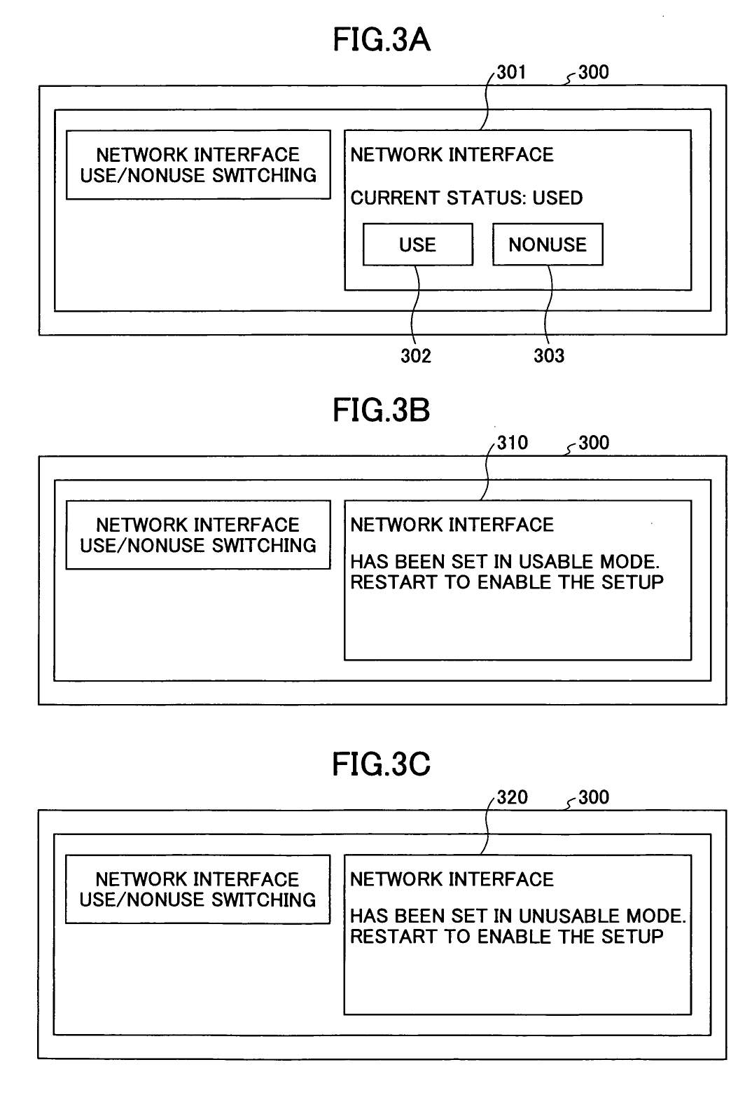

The process of OSC 132 controls the operations panel (which is explained below in conjunction with FIG. 3A through FIG. 3B) that serves as an information transfer medium between users and the control operations of the main part of the image forming/reproducing apparatus 100.

The process of FCS 133 provides the API 151 for allowing transmission and receipt of facsimiles in the application layer 104 via the integrated services digital network (ISDN) or other networks, entry, extraction and reading of various facsimile data items, and output processes of the received facsimiles. The process of ECS 134 controls the engine part including the black and white laser printer 112, the color laser printer 113 and other hardware items 111. The process of MCS 135 provides control on acquisition and release of system memory areas (not shown) or use of the memory devices (not shown). The process of SCS 136 provides management and interruption of applications, as well as general control of applications.

The process of SRM 137 performs, together with SCS 136, system control and manages hardware resources 103. For instance, the SRM 137 allocates the hardware resources 103 (including the black and white laser printer 112 and the color laser printer 113) according to an acquisition request from a higher layer, and controls the implementation of the requested hardware resource. To be more precise, the process of SRM 137 determines whether the requested hardware resource 103 is available (or is allocated to other acquisition requests), and reports the availability of the requested hardware resource 103 to the higher layer. The process of SRM 137 also schedules use of the hardware resources 103 according to acquisition requests from the higher layer, and directly executes the requested operations (such as paper feeding and image reproduction using the printer engine, acquisition of a system memory area, or file generation).

The universal operating system 140 has device drivers that provide necessary information required to drive the associated hardware resources 103, and is capable of controlling the communications interfaces, including the network interface and the USB interface. The image forming/reproducing apparatus 100 is connected to external equipment and devices via the communications interfaces to input and output image data.

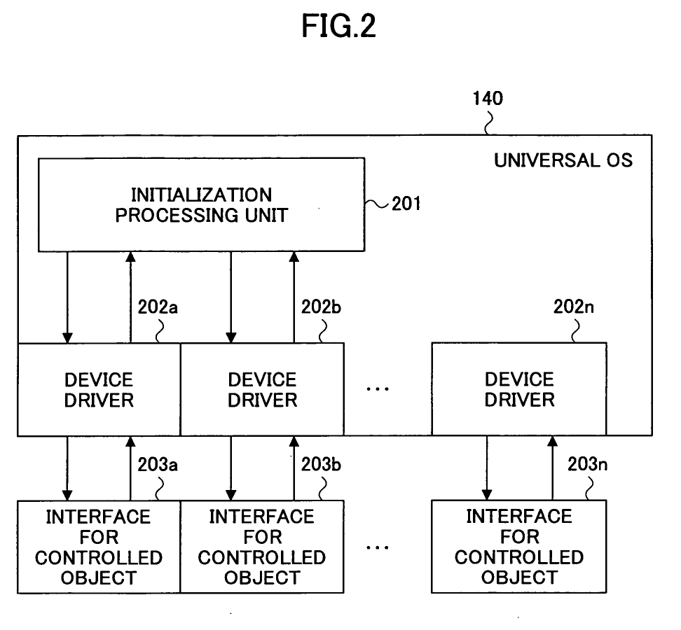

FIG. 2 is a functional block diagram of the universal operating system 140 according to an embodiment of the invention. The universal operating system 140 has an initialization processing unit 201 and a set of device drivers 202a through 202n. Each of the device drivers 202a-202n is configured to control the associated one of the interfaces 203a through 203n. The interfaces 203a-203n to be controlled are, for example, network interfaces or USB interfaces to allow the image forming/reproducing apparatus 100 to communicate with the external equipment and devices.

Upon power-on of the image forming/reproducing apparatus 100, the image forming/reproducing apparatus bootstrap unit 102 starts the application layer 104 and platform 106. The universal operating system 140 is initialized by the initialization processing unit 201. In general, the initialization process includes a device detecting process performed by each of the device drivers 202a-202n to detect the associated device connected via the network interface. Upon detection of the devices, initialization is further performed to control the environments of the interfaces 203a-203b and the device drivers 202a-202n so as to make them available on the software.

Next, explanation is made of the operations panel. The image forming/reproducing apparatus 100 of the embodiment is configured to allow a user to switch between the interface usable mode and unusable mode through the operations panel to select whether to use the interfaces 203a-202n including network interfaces and/or USB interfaces.

FIG. 3A illustrates an example of the network interface use/nonuse switching page (screen) displayed in the operations panel 300 of the image forming/reproducing apparatus 100. The interface switching screen includes a use/nonuse selecting page 301 in which a use button 302 and a nonuse button 303 are provided. The user can touch the use button 302 or the nonuse button 303 in the use/nonuse selecting page 301 to switch between the network interface usable/unusable modes. Instead of touching the operations panel, the modes may be switched using a mouse or a keyboard.

FIG. 3B illustrates an example of a usable status reporting message 310 displayed in the network interface use/nonuse switching screen when the use button 302 is selected, and FIG. 3C illustrates an example of a unusable status reporting message 320 displayed in the network interface use/nonuse switching screen when the nonuse button 303 is selected. When the use button 302 is selected by the user, the usable status reporting message 310 is displayed in the network interface use/nonuse selecting screen in the operations panel 300 to advice that the network interface has been set in the usable mode. The usable status reporting message 310 is, for example, “NETWORK INTERFACE HAS BEEN SET IN USABLE MODE. RESTART TO ENABLE THE SETUP.” On the other hand, when the nonuse button 303 is selected by the user, the unusable status reporting message 320 is displayed in the operations panel 300 to advice that the network interface has been set in the unusable mode. The unusable status reporting message 320 is, for example, “NETWORK INTERFACE HAS BEEN SET IN UNUSABLE MODE. RESTART TO ENABLE THE SETUP”. The user's selection result is also written in nonvolatile RAM (not shown). It should be noted that at this stage only the selection result is written in the nonvolatile RAM of the image forming and reproducing apparatus 100, and that the selection result is actually reflected in the image forming and reproducing apparatus 100 after the restart.

Next, explanation is made of the network interface use/nonuse switching operations for switching the communication interfaces (such as network interfaces or USB interfaces) between the usable mode and the unusable mode.

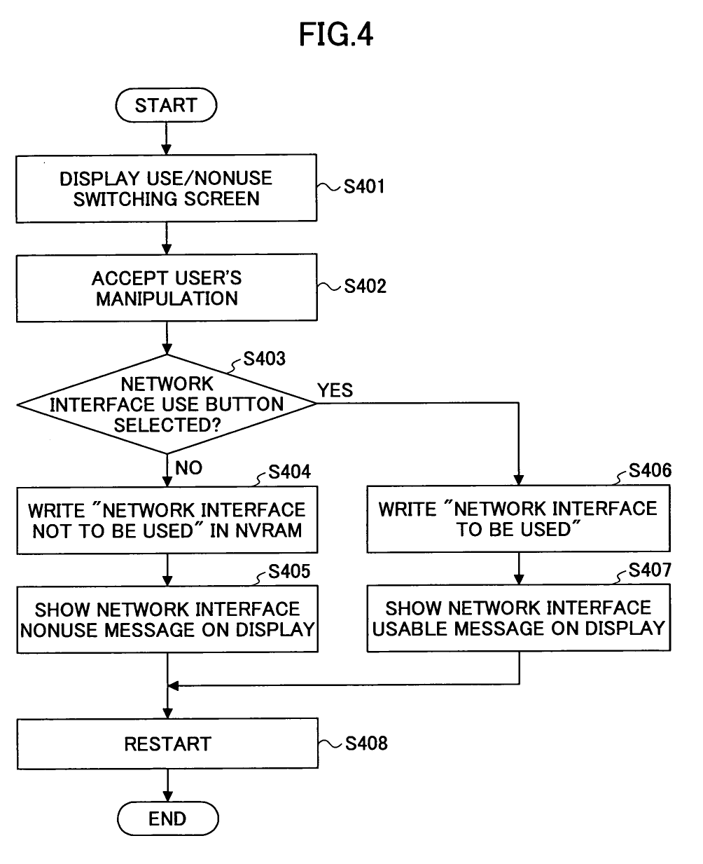

FIG. 4 is a flowchart of the network interface use/nonuse switching operation performed based on the user's selection through the operations panel 300. Although in this example the mode of a network interface is controlled, arbitrary communication interfaces 203a-203n including USB interfaces may also be controlled through the operations panel 300.

First, the use/nonuse switching screen with the use/nonuse selecting page 301 is displayed in the operations panel 300 of the image forming and reproducing apparatus 100 (step S401). The user can confirm the current mode of the target network interface from the use/nonuse selecting page 301, and can select the use button 302 or the nonuse button 303 as necessary. The user's selection is input through the operations panel 300 to the controller (not shown) such as a CPU of the image forming and reproducing apparatus 100 (step S402).

The controller of the image forming and reproducing apparatus 100 determines whether the user's selection is to set the communication interface in the usable mode (step S403). If the user's selection is to set the network interface unusable (NO in S403), the selection result representing “network interface not to be used” is written in the nonvolatile RAM (step S404), and at the same time, the unusable status reporting message 320 is displayed on the operations panel 300 (step S405). Then the image forming and reproducing apparatus 100 is restarted by the user (step S408), and the process terminates.

On the other hand, if the user's selection is to make the network interface usable (YES in S403), the selection result representing “network interface to be used” is written in the nonvolatile RAM (step S406), and at the same time, the usable status reporting message 310 is displayed on the operations panel 300 (step S407). The image forming and reproducing apparatus 100 is restarted by the user (step S408), and the process terminates.

If at the time of power-on of the image forming and reproducing apparatus 100 there is a communication interface set in the unusable mode, initialization of this communication interface is suspended in the bootstrap (initial environment setup process for the hardware and the software). Actual means for suspending the initialization of a communication interface depend on the type of the communication interface, and in general, suspending the communication interface from software via a register is employed.

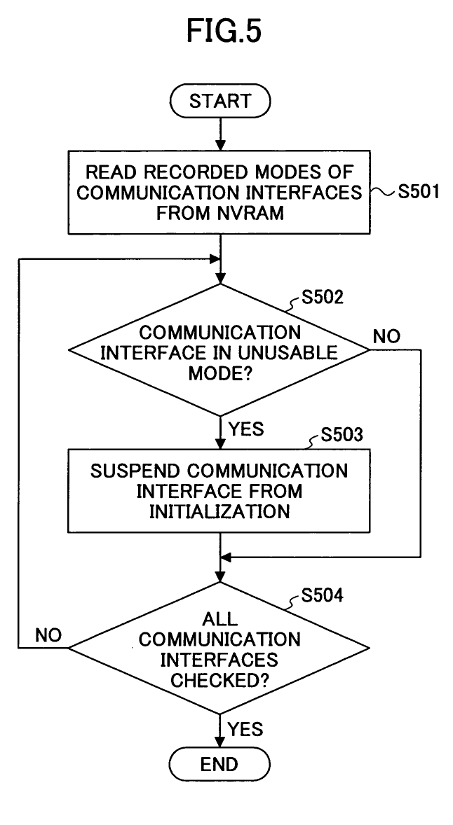

FIG. 5 is a flowchart of the network interface suspending operation in the bootstrap process according to an embodiment. First, the controller (not shown) of the image forming and reproducing apparatus 100 reads the recorded modes of the communication interfaces from the nonvolatile RAM (step S501). Each of the communication interfaces is currently set in either the usable mode or the unusable mode according to the user's selection, as illustrated in FIG. 4. Then it is determined by the controller whether the currently processed communication interface is set in the unusable mode (step S502). If this communication interface is in the unusable mode (YES in S502), the controller suspends the communication interface from the initialization, while maintaining its unusable mode (step S503). Then it is determined whether the modes of all the communication interfaces have been checked (step S504). If all the communication interfaces have been checked (YES in S504), the bootstrap (initial environment setup process) is terminated. If one or more communication interfaces remain unchecked (NO in S504), the process returns to step S502 to check the mode of the next communication interface.

If the currently processed communication interface is in the usable mode (NO in S502), this communication interface is not suspended from the initialization process and the process jumps to step S504 to determine whether all the communication interfaces have been checked. Steps S502 through S504 are repeated until all the communication interfaces have been checked. The process terminates when all the communication interfaces have been checked.

The device drivers 202a-202n of the operating system 140 (FIG. 2) may detect the existence of the communication interfaces 203a-203n and may be initialized in the usable mode even if the associated communication interfaces are in the unusable modes. In this case, the operation of the image forming and reproducing apparatus 100 become unstable and an unnecessary initialization process is performed requiring a long bootstrap time.

To avoid this situation, the image forming and reproducing apparatus 100 of the embodiment is designed so as to regard a device “undetected” if the associated communication interface is in the unusable mode and to report the processing result to the universal operating system 140 to make the associated one of the device drivers 202a-202n imperceivable.

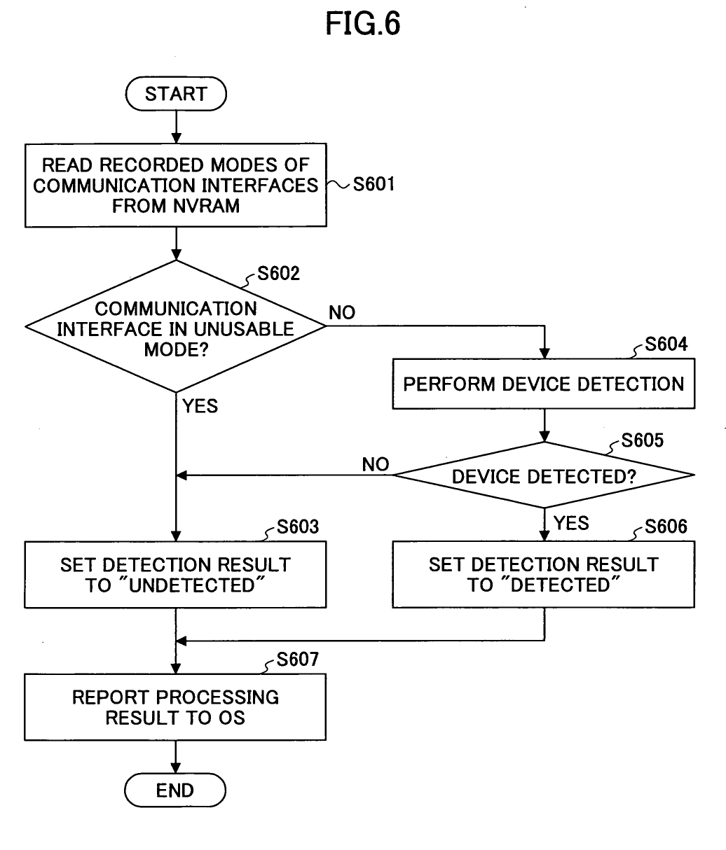

FIG. 6 is a flowchart of the device detection process of the device driver performed by the controller (not shown) of the image forming and reproducing apparatus 100 according to an embodiment of the invention. First, the controller reads the recorded modes of the communication interfaces from the nonvolatile RAM (step S601). Each of the communication interfaces

203 can be set in either the usable mode or the unusable mode by the user, as illustrated in FIG. 4. One of the communication interfaces is selected and it is determined by the controller whether this communication interface is in the unusable mode (step S602). If the currently processed communication interface is in the unusable mode (YES in S602), the device detection result is set to “undetected” without performing the actual detection by the associated device driver 202 (step S603). This processing result is reported to the universal operating system 140 (step S607), and the process terminates.

If the currently processed communication interface 203 is in the usable mode (NO in S602), the image forming and reproducing apparatus 100 causes the associated device driver 202 to detect a device connected to the currently processed communication interface 202 (step S604) in order to determine whether any device is connected to the communication interface 202 (step S605). If a device has been detected (YES in S605), the detection result is set to “detected” (step S606), and the processing result is reported to the universal operating system 140 (step S607).

If no device has been detected for the currently processed communication interface (NO in S605) by the associated device driver 202, the detection result is set to “undetected” (step S603) and the processing result is reported to the universal operating system 140 (step S607).

With the above-described arrangement, the user can set a communication interface currently not required into the unusable mode through the operations panel 300, and the power consumption can be reduced for this communication interface. In addition, the initialization time for the bootstrap process at power-on of the image forming and reproducing apparatus can be reduced for the communication interfaces set in the unusable mode.

The user can easily restore the desired communication interface from the unusable mode to the usable state through the operations panel 300 by simply selecting the use button.

Each of the device drivers 202a-202n detects a device for the associated one of the communication interfaces 203a-203n based on the usable or unusable mode of the communication interface. When the communication interface is in the unusable mode, device detection is omitted and this communication interface is removed from the initialization process in the bootstrap process. Because unnecessary initialization due to the existence of the communication interface itself can be prevented, the startup time of the image forming and reproducing apparatus 100 can be reduced, while preventing unstable operations and undesirable initialization.

Consequently, uneconomical power consumption and the bootstrap processing time can be reduced in the image forming and reproducing apparatus.

The communication interface control technique for an image forming and reproducing apparatus can be realized by installing a program in a personal computer or a work station and causing the personal computer or the work station to execute the program. The program may be recorded in a machine readable medium, such as a hard disk drive, a flexible disk, a CD-ROM, MO, DVD, or other suitable media, and read by the computer from the medium for execution. The program may be content delivered through a network, such as the Internet.

The above-described communication interface controlling method is especially suitable for a multi-function peripheral with multiple types of image reproducing functions, such as a copy function, a facsimile function, and/or a scanner function and connectable to external equipment and devices via various types of communication interfaces.

This patent application is based on and claims the benefit of the earlier filing date of Japanese Patent Application No. 2005-112435 filed Apr. 8, 2005, the entire contents of which are hereby incorporated by reference.

What is claimed is:

1. An image forming and reproducing apparatus furnished with one or more communication interfaces connectable to external devices so as to transmit and receive image data items to and from the external devices, comprising:
a communication interface mode setting unit configured to allow a user to set each of the communication interfaces in a usable mode or a unusable mode; and
a controller configured to detect the currently set mode of each of the communication interfaces when the image forming and reproducing apparatus is powered on and to determine whether to initialize each of the communication interfaces based on the detected mode.

2. The image forming and reproducing apparatus of claim 1, further comprising:
a storage unit configured to store the modes of the communication interfaces;
wherein the controller reads the modes of the communication interfaces from the storage unit to determine whether to initialize the communication interfaces when the image forming and reproducing apparatus is powered on.

3. The image forming and reproducing apparatus of claim 1, further comprising:
a bootstrap unit configured to start up the image forming and reproducing apparatus when the image forming and reproducing apparatus is powered on;
wherein the controller causes the bootstrap unit not to start up the communication interface set in the unusable mode.

4. The image forming and reproducing apparatus of claim 1, further comprising:
one or more device drivers provided corresponding to the communication interfaces;
wherein if the communication interface is in the unusable mode, the controller does not activate the associated device driver when the image forming and reproducing apparatus is powered on.

5. The image forming and reproducing apparatus of claim 3, further comprising:
one or more device drivers provided corresponding to the communication interfaces;
wherein if the communication interface is in the unusable mode, the controller causes the bootstrap unit not to start the associated device driver when the image forming and reproducing apparatus is powered on.

6. A communication interface controlling method for an image forming and reproducing apparatus connected via one or more communication interfaces to external devices for image data transmission, comprising the steps of:
setting each of the communication interfaces in a usable mode or an unusable mode; and
controlling initialization of the communication interface based on the mode when the image forming and reproducing apparatus is powered on.

7. The communication interface controlling method of claim 6, further comprising the step of:
suspending the initialization of the communication interface when the image forming and reproducing apparatus is powered on if the communication interface is set in the unusable mode.

8. The communication interface controlling method of claim 6, further comprising the steps of:
providing one or more device drivers to the communication interfaces; and
suspending initialization of the device driver when the image forming and reproducing apparatus is powered on if the communication interface corresponding to the device driver is set in the unusable mode.

9. A program product installable in an image forming and reproducing apparatus to cause the apparatus to execute the process of:
accepting user's selection for setting each of communication interfaces furnished in the image forming and reproducing apparatus in a usable mode or an unusable mode;
storing the selected modes of the communication interfaces; and
controlling initialization of each of the communication interfaces based on the stored mode when the image forming and reproducing apparatus is powered on.
